(19) United States
(12) Patent Application Publication
(10) Pub. No.: US 2023/0417239 A1
(43) Pub. Date: Dec. 28, 2023

(54) METHOD AND APPARATUS FOR RECOVERY OF LEAKING GASES FROM COMPRESSION AND REGULATION SYSTEMS

(71) Applicant: Evan Scott Guy, Magnolia, TX (US)

(72) Inventor: Evan Scott Guy, Magnolia, TX (US)

(21) Appl. No.: 17/935,525

(22) Filed: Sep. 26, 2022

Related U.S. Application Data
(60) Provisional application No. 63/473,838, filed on Jun. 27, 2022.

(51) Int. Cl. F17D 5/02; F17D 5/00; F04B 53/14; F04B 19/22

(52) U.S. Cl. CPC F17D 5/02; F04B 19/22; F04B 53/144; F17D 5/005

(57) ABSTRACT

A system and method for recovering fugitive natural gas emissions from compressors. Leak capture devices can be connected to piston rods of the compressor for collecting emissions both during operation and periods where the compressor is shutdown. Captured natural gas is repressurized with cylindrical pumps based on the flow rate of the captured emissions. The equipment can also be configured for capturing blow down events of the equipment.

### FIELD OF THE INVENTION

This technology relates in general to natural gas compressions systems, and more particularly to systems for recovering fugitive natural gas leaks from compression equipment.

### DESCRIPTION OF THE PRIOR ART

Gas is compressed to increase its density for the purpose of well production, transportation, and distribution. Upon arriving near its point-of-use destination, regulators are used to reduce the pressure. The most common types use pressure differentials between the high pressure and reduced pressure lines to power actuators that open and close pressure regulating valves. Gas compressors are typically one to three stage double-acting reciprocating-piston compressors, depending on the amount of compression required for a specific installation.

Natural gas compressors are found at gas wellhead locations and throughout pipelines that transport gas. Typically, these compressors are driven by reciprocating-piston internal-combustion engines. These use natural gas as fuel as it is readily available. Compressors may also be driven by turbine engines or electric motors.

Reciprocating-piston compressors leak natural gas between the piston rod and packing seals. The leakage is a function of pressure differential across the seals and hardware conditions. The emissions from these leaks are allowed to escape to atmosphere.

Natural gas compressors and compressor stations (containing multiple compressors), also perform “blow-down” events to de-pressurize components, compressors, and sections of piping for the purpose of pumping reduction, maintenance, or failure.

In recent years, global climate change resulting from human activity has become apparent. Gradual global warming is beginning to result in scientifically documented changes in weather patterns, ocean temperatures, and a long list of weather-related changes, many of which have an increasingly adverse effect on earth's environment. Scientists have identified specific gases, termed greenhouse gasses (GHGs), which have the detrimental effect of trapping heat within the earth's atmosphere. Methane, the predominant constituent in natural gas, is particularly damaging. Methane is 86 times more powerful in its contribution to global warming than carbon dioxide (CO2) over a 20-year time span. Because of this, emissions reduction programs are in place and commonplace in industry. Natural gas systems have numerous sources of fugitive emissions to the atmosphere.

Natural gas transportation and distribution systems rely on pneumatically controlled pressure-regulation systems designed to bleed off excess pressure. This bleed gas is a relatively small quantity, but regulation is constant and bleed gasses are very frequent with this type of pressure regulation. Currently, most regulating stations bleed excess pressure in the form of gas emissions to the atmosphere. Once natural gas was realized for its environmental damage, the leakage from the pressure regulation process has been more closely scrutinized. Therefore, there is a need in the art for systems to capture these various emission sources and reduce natural gas emissions to the atmosphere.

### SUMMARY OF THE INVENTION

A first embodiment of the present technology can provide for a system for recovering natural gas from a compression system. The system can include a natural gas compressor, a gas capture device positioned within the compressor to capture gas before leaking from the compressor, a recovered gas collection tank in fluid communication with the gas capture device, and a recovered gas compression system.

In some embodiments, the gas collection system can collect gas that has leaked past seals on the piston rod of the compressor. The gas can be collected while the piston rod is in motion. Here, the gas capture device can include a housing assembly with a component that surrounds the piston rod. There can be tubes in communication with the housing assembly to channel leaked gases to the collection tank.

Alternatively, gas that has leaked past seals on the piston rod can be collected while the piston rod is stationary. In this embodiment, the gas collection system can include a housing assembly with a component that surrounds the piston rod for collecting the leaked gasses. There can be tubes in communication with the housing assembly to channel leaked gases to the collection tank.

In some embodiments, the recovered gas compression system can also include a speed control assembly. In other embodiments, the system can also include a diagnostic module for monitoring the amount of gas that was recovered.

A second embodiment of the present technology provides a system for compressing recovered natural gas. The system can include cylindrical pumps connected to a leakage gathering tank, a speed control assembly connected to the leakage gathering tank, and an isolation valve between the speed control assembly and the cylindrical pumps. The speed control assembly can control the pumping speed of the cylindrical pumps. In some embodiments, there can be between three and five cylindrical pump.

The cylindrical pumps can contain cylinders with pistons. The pistons can have a larger center diameter and smaller outer diameters. The pumps can compress the captured natural gas from each side of the pumps. The pumps can also have a gas control assembly to direct high and low pressured gasses to either end of the pumps to ensure correct operation of the pumps.

The speed control assembly can include a cam and roller system for controlling the cylindrical pumps based on predetermined pressure levels. A cam and roller system can activate, de-activate, and regulate the cylindrical pumps in sequential fashion. This can be done through the use of a taper valve associated with each cylindrical pump driven by the cam and roller system. The taper valve can proportionally control the pump speed based on position of the cam and roller system.

The isolation valve can be a valve assembly to let pressurized gas bypass the speed control assembly. This can allow activation of all the cylindrical pumps at a maximum capacity. The pumping speed of the cylindrical pumps can be determined by a pressure in the leakage gathering tank in some embodiments.

A third embodiment of the present technology provides for a method of recovering natural gas from a compression system. This can be performed by first connecting a gas capture device to a natural gas compressor. The gas that is recovered from the gas capture device can then be collected in a collection tank. The recovered gas in the collection tank can further be pressurized with a gas compression system and returned to the main natural gas system.

In some embodiments the gas is collected when the piston rod or rotating shaft is in motion. In other embodiments, the gas is collected when the piston rod or rotating shaft is stationary. The pressurization rate can further be based on the pressure of the recovered natural gas in the collection tank. The method can also include collecting blowdowns within specific sections of the pipeline system. Additionally, the flow rate of the collected natural gas can be monitored, and an operator can be notified when the flow rate exceeds a predetermined threshold.

### BRIEF DESCRIPTION OF DRAWINGS

The present technology will be better understood on reading the following detailed description of non-limiting embodiments thereof, and on examining the accompanying drawings, in which:

FIG. 1 is an embodiment of a natural gas compressor with gas recovery system according to an embodiment of the present technology.

FIG. 2 is an exemplary prior art double-acting reciprocating-piston compressor.

FIG. 3 is the compressor of FIG. 2 with gas recovery equipment according to an embodiment of the present technology.

FIG. 4 is a magnified region of FIG. 3 highlighting the connection of the gas recovery equipment to the compressor.

FIG. 5 is another embodiment of a gas recovery system with static seal assembly.

FIG. 6 is a magnified region of FIG. 5 highlighting the seal system of the present technology.

FIG. 7 is an alternate embodiment of a gas recovery system with rod seal assembly.

FIG. 8 is a magnified region of FIG. 7 highlighting the seal system of the present technology.

FIG. 9A is a gas recovery pump assembly according to an embodiment of the present technology.

FIG. 9B is an embodiment of a piston assembly which can be used in the gas recovery pump assembly of FIG. 9A.

FIG. 10 is a magnified region of the pump valve assembly of FIG. 9A.

FIG. 11 is an embodiment of a cylinder head and trigger valve assembly according to the present technology.

FIG. 12 depicts an embodiment of a speed control assembly according to the present technology.

FIG. 13 is a magnified view of the regulator valve assembly shown in FIG. 12.

FIG. 14 is a graph showing pumping output as a function of plate cam position for each of the three pumps of the speed control assembly.

FIG. 15 depicts an embodiment of a blow-down diverter valve according to the present technology.

FIG. 16 is an embodiment of a seal health monitoring system according to the present technology.

FIG. 17 depicts a 2-stage pump assembly for use with the current technology.

### DETAILED DESCRIPTION OF THE INVENTION

The foregoing aspects, features, and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The technology, however, is not intended to be limited to the specific terms used, and it is to be understood that each specific term can include equivalents that operate in a similar manner to accomplish a similar purpose.

When introducing elements of various embodiments of the present technology, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment,” “an embodiment,” “certain embodiments,” or “other embodiments” of the present technology are not intended to be interpreted as excluding the existence of additional embodiments that also incorporate the recited features. Furthermore, reference to terms such as “above,” “below,” “upper,” “lower,” “side,” “front,” “back,” or other terms regarding orientation are made with reference to the illustrated embodiments and are not intended to be limiting or exclude other orientations.

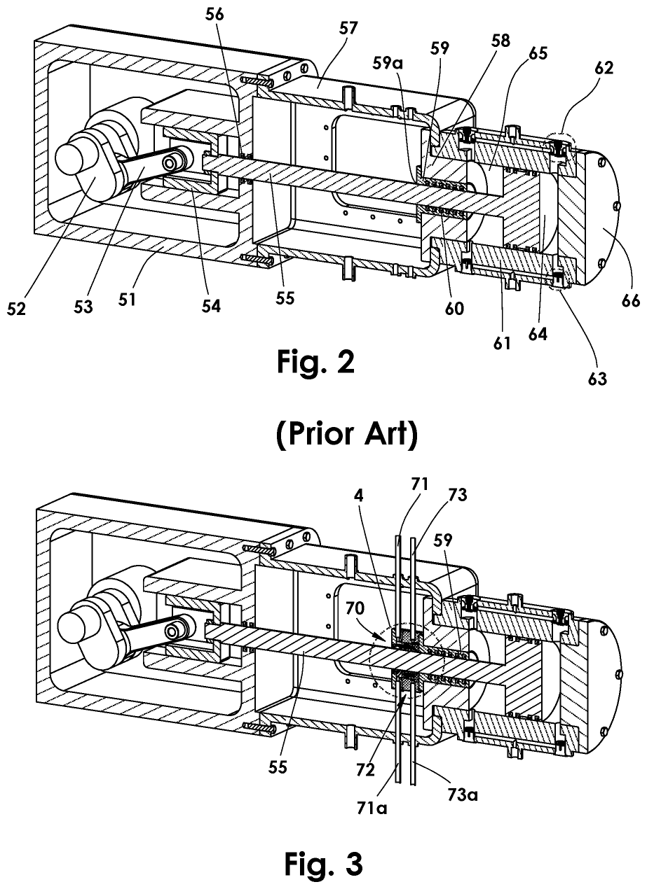

In typical compressors, a distance piece (shown in FIG. 2) can be used to separate the crankcase assembly from the natural gas compression assembly. The crankcase assembly can be an oil-lubricated system for converting the rotational energy from an internal-combustion engine or electric motor to a linear reciprocating motion for compressing the natural gas. Bearing failures in the crankcase assembly can result in temperatures sufficient to ignite natural gas.

Generally, the distance piece can achieve sufficient separation that any leaks of natural gas at the seal pack would not be of high enough concentration to be combustible at the crankcase assembly. However, seal failures can result in high leakage rates of natural gas and have resulted in crankcase explosions in the wrong circumstances. The present technology can capture these natural gas leaks before reaching atmosphere to further prevent such problems due to seal failure.

The present technology can be a system that is fitted to existing natural gas compressors. The system can capture gas leaked through the compressor seal packs. The leaked gas can be captured before it is exposed to air so that all that is captured is gas. This gas can then be re-introduced to the pipeline system in one of two places.

If the compressor power source is an internal combustion engine, the captured gas can be re-introduced into the gas fuel source for the engine, typically at a pressure of 100 to 150 psig. If the power source does not use natural gas for fuel, such as if the power source is an electric motor, the leaked gas can be re-introduced into the compressor inlet, typically at pressures of up to 600 psig, and can require two stages of compression.

This technology can work with both reciprocating and rotary compressors. Rotary compressors can be of the roots, screw, centrifugal, and/or turbine type.

This technology can include either one or two assemblies around the diameter of the piston rod (or rotating shaft) and is attached to the end of the packing seal cartridge. The rod capture assembly can gather leakage of an operational compressor, while the static seal assembly can capture leakage of a non-operational compressor.

The rod capture assembly can capture natural gas at a pressure of, for example, 0-10 psig. The captured natural gas can be restricted to enable a variable speed recovery pump that can track the natural gas leakage rate. A slight back-pressure on the system can prevent pressurization of the distance piece outside of normal operating conditions.

The rod capture assembly can be assembled using a split-seal or single-piece seal onto either an assembled or disassembled compressor. The use of the single-piece seal can result in better natural gas capture rates.

The static sealing system can be used with compressors driven by internal combustion engine using fuel supplies with a range of 100-150 psig. Natural gas captured by the static sealing system can be directed to the fuel supply line for the remaining operating compressors, which can require substantially more natural gas than the leakage rate from non-operational compressors as a fuel supply.

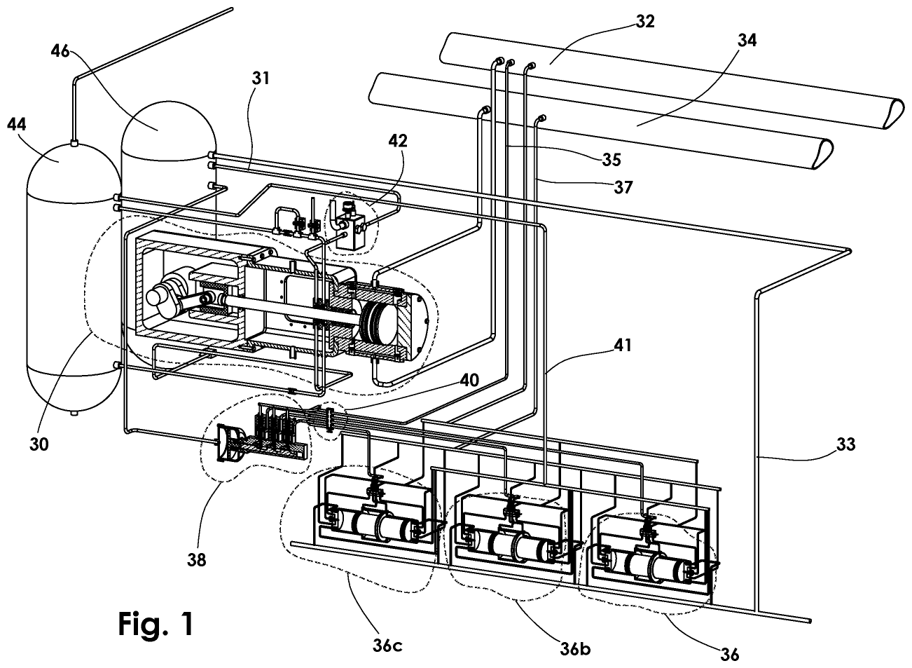

FIG. 1 is a first embodiment of the present technology including a typical compressor 30, a high-pressure pipeline 32, and a lower-pressure pipeline 34 that can be present in compressor installations. Leakage from the packing seals of the compressor can be collected in tank 46 through line 31 at a pressure of about 0-20 psig. Three pump assemblies 36, 36b, 36c can draw the leakage from leakage tank 46 through line 33 and compress and introduce it into fuel supply tank 44 through line 41 at a pressure of 100-150 psig.

The pump assemblies 36, 36b, 36c can be pneumatically driven by the pressure differential between high pressure pipeline 32 and lower pressure pipeline 34, through lines 35 and 37, respectively.

The pump(s) 36, 36b, 36c can be variable speed in order to closely match the leakage rate. The speed control assembly 38 can sequentially modulate driving pressure to the three pump assemblies 36, 36b, 36c based on the demand for leakage pumping.

The isolation valve 40 can be used to circumvent the speed control assembly 38 for the purpose of converting the pump assemblies 36, 36b, 36c from leakage mitigation to capture of blow down volumes. For capturing blow downs of specific components and/or piping conduits, the system can be connected to a source within the area to be blown down. When blow down mode is selected, the speed control assembly can be bypassed such that all pumps 36, 36b, 36c operate at full capacity.

The diagnostic module 42 can have multiple sensors that indicate excessive leakage from the seal pack. One module can be required for each compressor ‘throw’ of multi-cylinder compressors.

FIG. 2 is a sample prior art depiction of a double-acting reciprocating-piston compressor. The main structure, housing 51, can be firmly affixed to the ground and can provide support for crankshaft 52, crosshead 54, piston rod 55, distance piece 57, and seals 56. The piston rod 55 can be coupled to crosshead 54 and piston 64. Cylinder 61, inlet valve assemblies 62, discharge valves 63, and cylinder head 66 can comprise a typical compressor.

Pressure in the compressor volume 65 can leak through the multiple packing seals 60 and can result in leakage between the piston rod 55 and the packing seal cartridge 59. Leaked gases can flow into the distance piece 57 and out to the atmosphere through the annular clearance 59a.

FIG. 3 shows additions to the compressor of FIG. 2 according to an embodiment of the present technology. The rod capture assembly 70 and static capture assembly 72 can be added to the assembly of FIG. 2. The purpose of these assemblies can be to capture leakage between the piston rod 55 and packing seal cartridge 59.

The rod capture assembly 70 can capture leakage from the periphery of piston rod 55 and can divert the leakage through lines 71 and 71a. Both pipes can flow to the same tank. The purpose of redundant pipes can be to promote oil in the lower portion of the rod capture assembly to flow slowly to the tank. This can keep the lighter gases at the top and the mist and liquids near the bottom. Light gas to be used further can be taken from the top of the tank without the heavy and/or liquid components at the bottom. Similarly, the static capture assembly 72 can divert leakage through lines 73 and 73a.

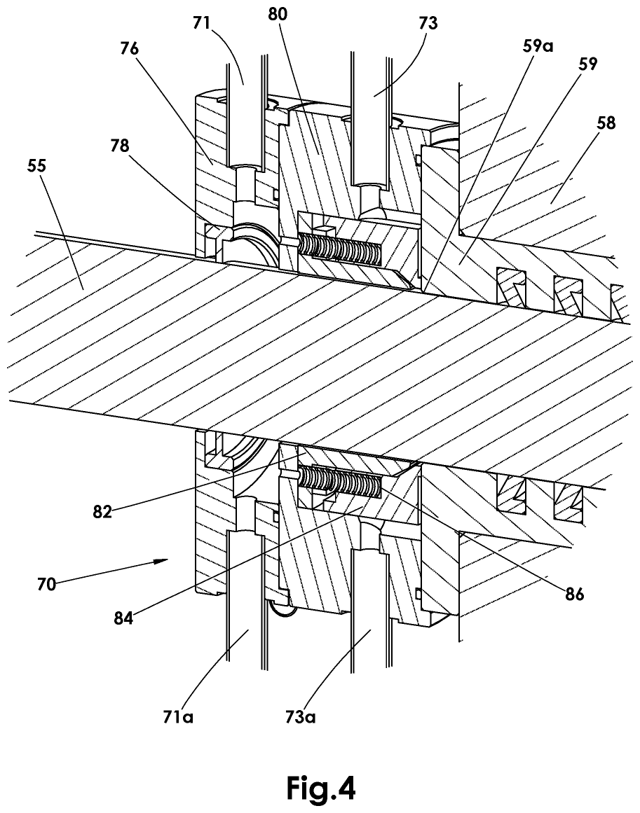

FIG. 4 shows a magnified region of the embodiment of the technology shown in FIG. 3. Piston rod 55, cylinder frame head 58, and packing seal cartridge 59 can be pre-existing parts of the compressor. This technology can include two sealing systems added to existing hardware. The static seal assembly housing 80 can abut the existing packing seal cartridge 59, and can house the clamping piston 84, clamping piston return springs 86, and flexible sealing sleeve 82. These parts can comprise the static seal assembly that can be activated when the compressor is shut off. Upon compressor stoppage this system can be activated, diverting leakage gas into lines 73 and 73a.

Abutting housing 80 can be rod seal housing 76 that contains rod seal 78. These two parts can comprise the rod seal assembly 70. When the compressor is operational, this system can collect the leakage flow from the annular clearance 59a and divert the leakage flow into lines 71 and 71a.

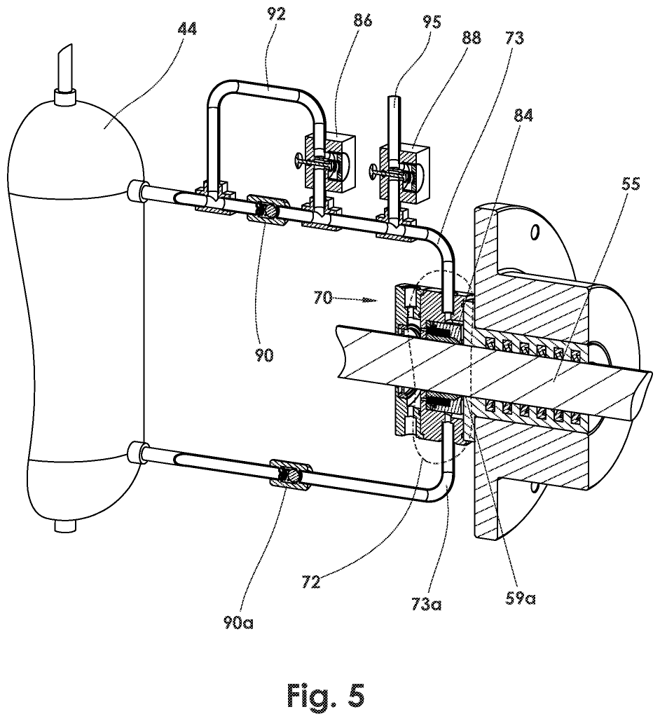

FIG. 5 shows another embodiment of the present technology including the gas capture system and activation/deactivation system of the static seal assembly 72. When this assembly is deactivated during compressor operation, the clamping piston 84 can be relaxed and leakage flow through annular clearance 59a can be permitted to flow to the rod seal assembly 70 for capture. Flow through the static seal assembly 72 may not be sufficient to provide pressure differential required for activation of the clamping piston 84. When activated, the static seal assembly 72 can capture leakage from the annular clearance 59a and divert it through lines 73 and 73a, check valves 90 and 90a, and into fuel supply tank 44. To facilitate activation/deactivation of the static seal assembly 72, activation line 92, deactivation line 95, and momentary valves 86 and 88 can be added. Upon compressor shut down, the activation of the static seal assembly 72 can be effected by momentarily opening valve 86. This can provide a pressure surge from tank 44 into static seal assembly 72 and can urge clamping piston 84 to move and effect a sealed condition. Conversely, the momentary opening of valve 88 can reduce the pressure in the static seal assembly 72 through vent pipe 95, causing the clamping piston 84 to relax and allow leakage flow through static seal assembly 72.

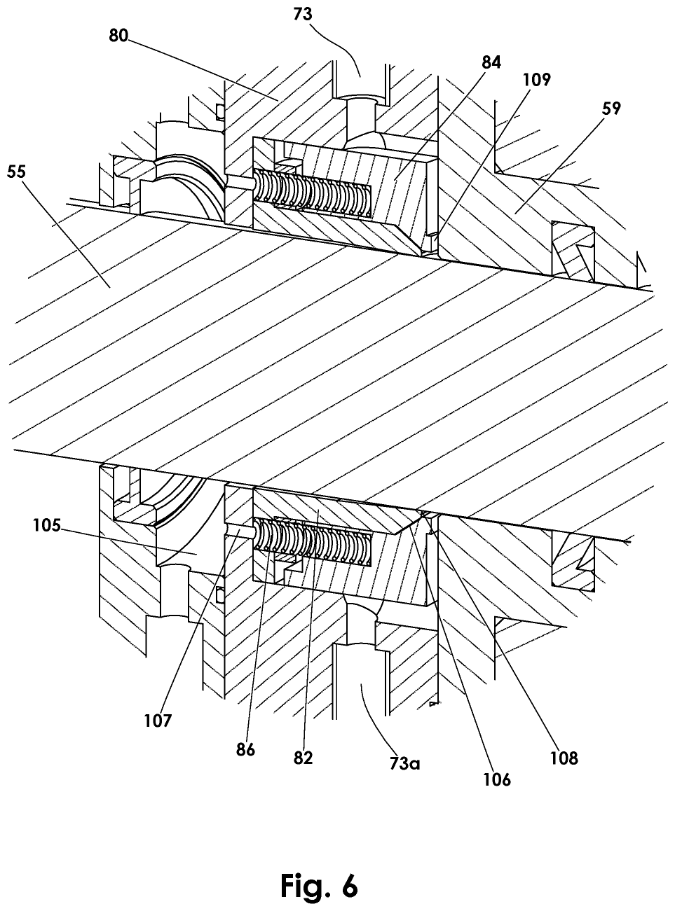

FIG. 6 shows an embodiment where the clamping piston 84 has moved leftward, evident by the gap 109 between packing seal cartridge 59 and clamping piston 84, as the result of a momentary pulse of pressure from tank 44 through line 73. This movement can cause the internal conical surface of clamping piston 84 to contact external conical surface 106 of flexible sealing sleeve 82. This contact can compress the flexible sealing sleeve such that the clearance between piston rod 55 and flexible sealing sleeve 82 can be eliminated at location 108, resulting in a sealed condition. A momentary venting of the pressure in line 73 can result in deactivation of the static seal assembly as the clamping piston return springs 86 urges the clamping piston 84 to the right until it contacts the packing seal cartridge 59. This can release the compression of the flexible sealing sleeve 82 around piston rod 55, allowing leakage flow through the annular clearance.

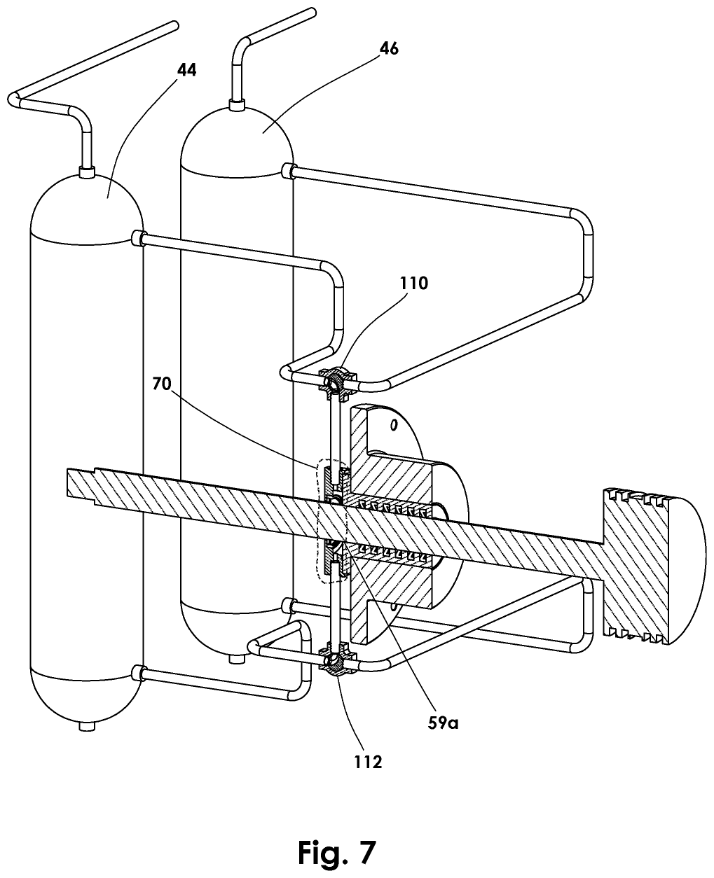

FIG. 7 shows an alternative embodiment of leakage flow capture for the static seal assembly 72 utilizing a combined sealing system using rod seal assembly 70 that can direct leakage from annular clearance 59a of a non-running compressor to fuel supply tank 44 if 3-way valves 110 and 112 are positioned accordingly. An operational compressor can require that leakage flow be directed into leakage gathering tank 46. This can be done by rotating the linked valves 110 and 112 to the appropriate position.

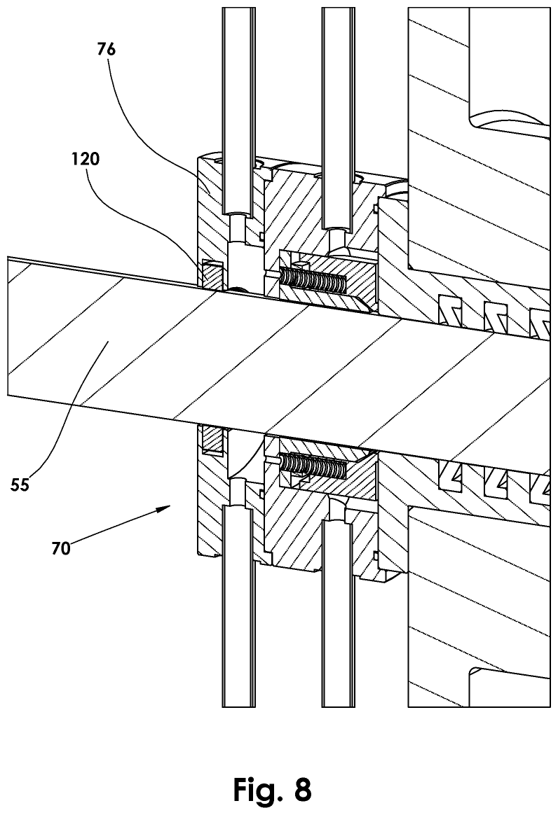

FIG. 8 shows an alternative embodiment of leakage flow capture for the rod seal assembly 70. There may be applications where it is preferred to eliminate dynamic seal contact stress with piston rod 55. Rather than mounting a seal that physically contacts the shaft, a close-fitting rod bushing 120 can be utilized. It can have a close axial fit and generous radial fit sufficient to accommodate piston rod 55 deflection within housing 76. This method can reduce but not entirely eliminate leakage.

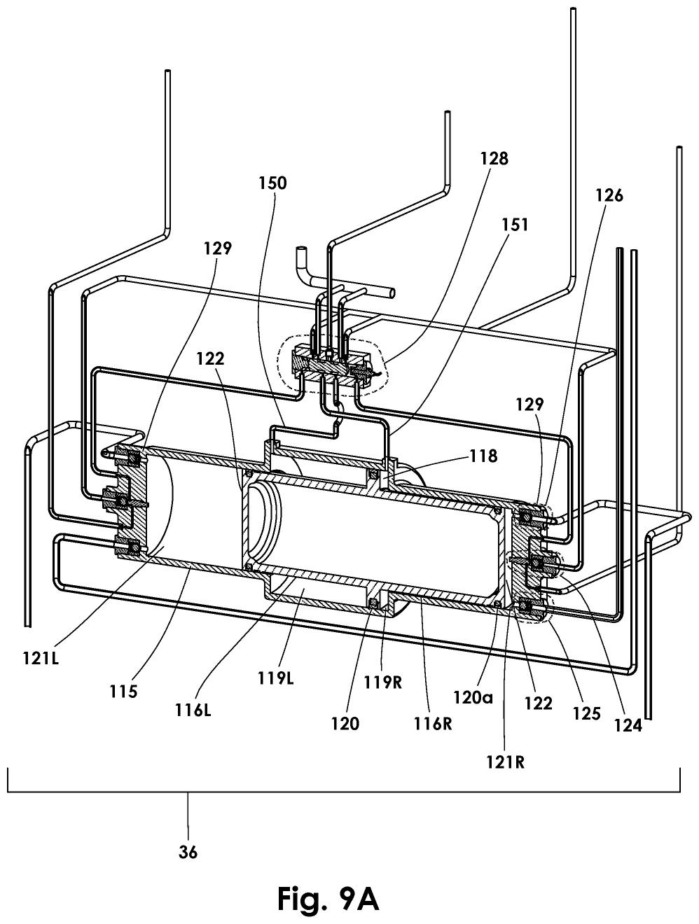

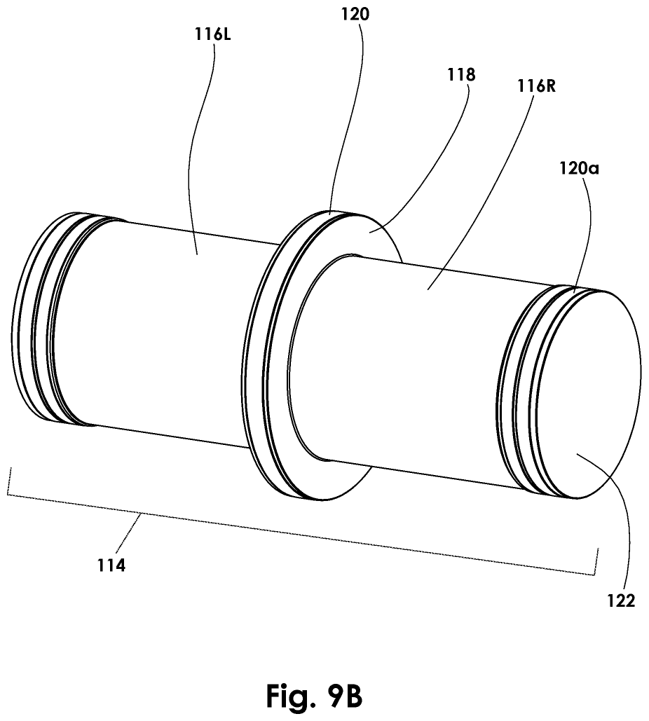

FIG. 9A shows pump assembly 36 according to an embodiment of the technology. The pump assembly can be pneumatically driven by alternating the pressures acting on major piston 118 within major bores 119L and 119R. Minor pistons 116L and 116R can reciprocate in bores 121L and 121R, respectively, within pump housing 115 to compress captured leakage gases. Each end of the pump assembly can have a cylinder head 129 that can have a suction valve assembly 126, a discharge valve assembly 125, and a trigger valve assembly 124.

The pump valve assembly 128 can control the alternating pressures in lines 150 and 151 that drive opposite sides of major piston 118. As the piston assembly approaches the end of its stroke, it can contact the end of the trigger valve assembly 124, initiating a shift within the pump valve assembly 128. This can cause the pressures in lines 150 and 151 to reverse.

FIG. 9B depicts an embodiment of the piston assembly 114. Major piston 118 can be structurally connected to minor pistons 116L and 116R that extend equally and opposite in the axial direction. Piston heads 122 can be connected to minor pistons 116L and 116R. The major piston and minor pistons can use appropriate seals 120 and 120a to seal in their respective bores.

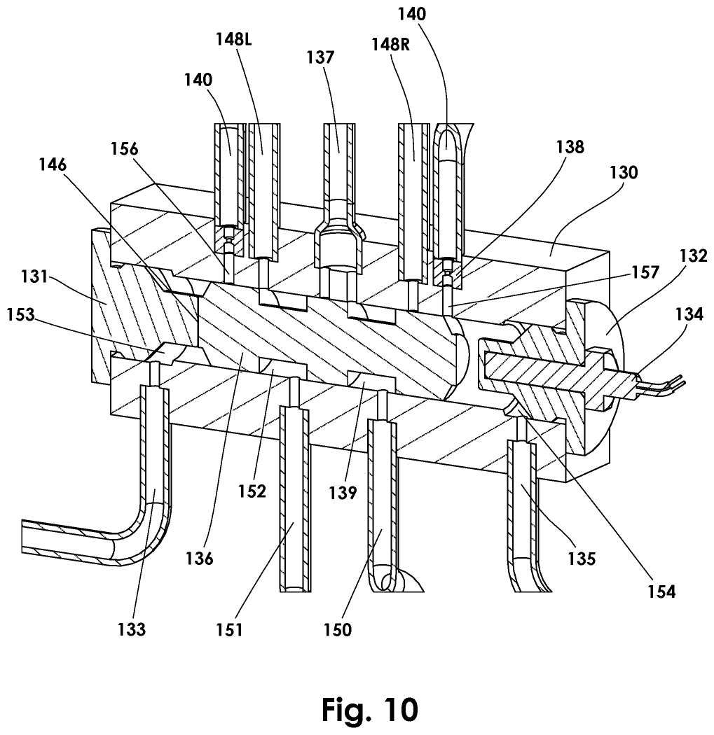

FIG. 10 shows details of an embodiment of the pump valve assembly 128. The spool valve 136 can reciprocate within valve body 130 and can have its travel limited by the end plugs 131 and 132. The spool valve 136 is shown in its left-most position and can be in contact with end plug 131 at location 146. End plug 132 can have mounting provisions for sensor 134. This can sense each time that the spool valve 136 shifts from one position to the other. This information can be used for data logging of the number and frequency of the pumping cycles. Data analysis can determine actual gas leakage that has been mitigated and can show packing seal wear trends that can alert the need for compressor service.

The trigger pulse line 133 can communicate with end volume 153 and the trigger pulse line 135 can communicate with end volume 154. The other end of each line 133 and 135 can be connected to its respective trigger valve assembly 124, mounted to the pump assembly cylinder head 129. Each trigger valve assembly 124 can be normally open and can always communicate with a low-pressure source except when the trigger valve assembly is contacted by piston head 122.

The design of the pump valve assembly can contain a feature to ensure the spool valve movement is positive and holds its position until commanded to move. In operation, there can be low pressure in end volume 153 and medium pressure in end volume 154. This pressure differential can be required to keep the spool valve locked in this position. In order to shift the spool valve 136 to its right-most position, a high-pressure pulse can be briefly sent to volume 153. At this instant, the pressure in volume 153 can be high and the pressure in volume 154 can be medium. This differential pressure can be required to command a change in spool valve position when the trigger valve assembly is energized.

Assuming the pressure conditions of the pump valve assembly shown in FIG. 10 are typical of normal operation, other than the brief triggering condition that occurs at the end of the piston's stroke, the pressure in volume 153 can be low and the pressure in volume 154 can be medium. The pressure in volume 153 can be low because line 133 can be connected to the normally open trigger valve assembly 124 and can be vented to low pressure, and high-pressure port 156 can be blocked. The pressure in volume 154 can be medium because it communicates with the normally open trigger valve assembly 124, but the addition of high pressure through unblocked high-pressure port 157 can admit pressurized flow into volume 154. The system can be tuned so that the medium pressure can be between the low pressure and high pressure by introducing flow throttling with orifice 138 and orifice 166. An optimal medium pressure value can be selected such that ample pressure differential can be available across the spool valve at both steady state for holding the spool valve in a fixed position (med-low pressure differential) and also during the transient pulse when the trigger valve assembly is activated to quickly shift the spool valve to the other end of its travel (high-med pressure differential).

Lines 140 can be high-pressure, unregulated, and connected to high-pressure pipeline 32. Lines 148L and 148R can be variable high-pressure and connected to the outlet of the speed control regulator 38. Line 137 can be connected to the lower-pressure pipeline 34. Line 151 can communicate with volume 119R and line 150 can communicate with volume 119L. The piston assembly 114 can move to the left because regulated high-pressure in line 148L communicates through annular groove 152 with line 151 and volume 119R. Further, lower-pressure line 137 can communicate through annular groove 139 with line 150 and volume 119L. This pressure differential across major piston 118 can drive the piston assembly 114 in order to pump leakage gases with minor pistons 116L and 116R.

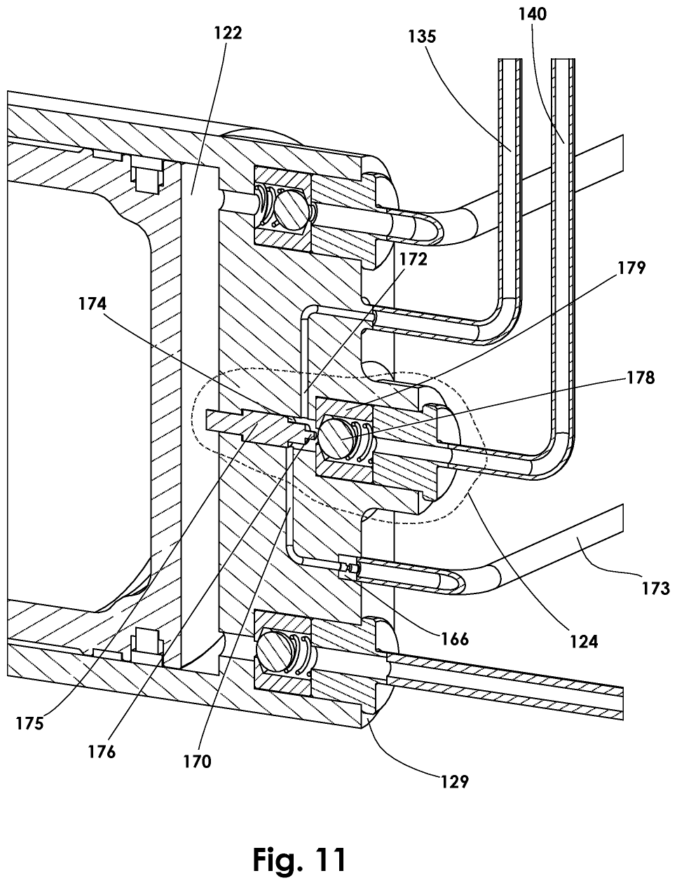

FIG. 11 shows detail of the cylinder head 129 and the trigger valve assembly 124 according to an embodiment of the technology. The trigger pulse line 135 that connects to the valve body 130 can normally be at a low pressure due to valve step 174 not covering the low-pressure passage 170. As the piston assembly approaches the end of its stroke, the piston head 122 can strike the trigger valve plunger 175 and urge it to the right, closing off low-pressure passage 170. The trigger actuator pin 176 can then strike the check ball 178, urging it off of the seat of trigger valve body 179. This momentary event can cause the high-pressure line 140 to communicate through flow port 172 with trigger pulse line 135. This can cause spool valve 136 to rapidly shift position to the other end of its stroke. This can cause a pressure reversal on major piston 118 which can drive the piston assembly in the opposite direction.

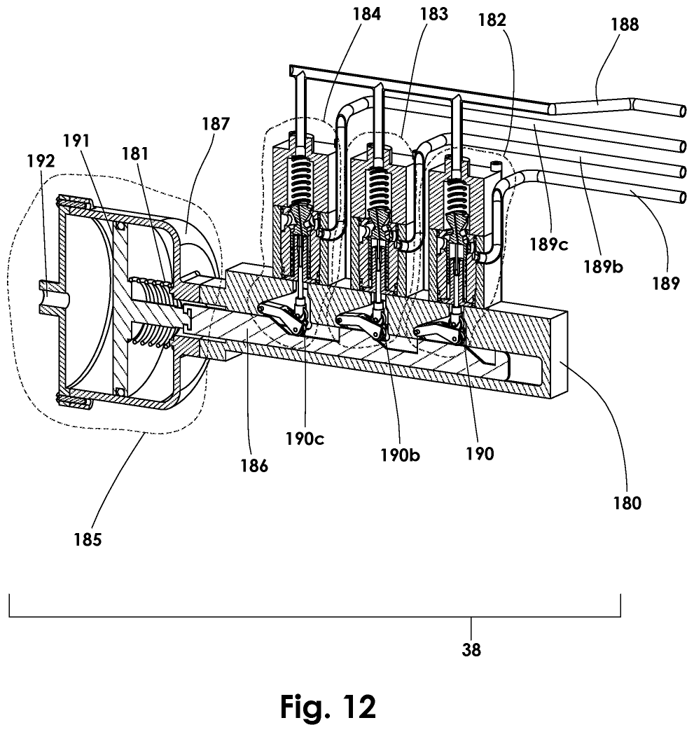

FIG. 12 shows the speed control assembly 38 according to an embodiment of the present technology. The leakage mitigation properties of this technology lie in one or more pumps that can vary pumping capacity to closely match the leakage rate of natural gas. This embodiment shows three pumps 36, 36b, and 36c, but up to 5 pumps tied together is feasible. Actuator assembly 185 can use the low pressure from leakage gathering tank 44 through port 192 to effect movement of a diaphragm or piston 191 within the actuator housing 187. The diaphragm or piston 191 can be linked to plate cam 186 and move to a position that is proportionate to the tank pressure due to the opposing force of actuator return spring 181. The higher the tank pressure, the more that plate cam 186 can move to the right within regulator body 180.

As the gas leakage from a compressor increases, the pressure in leakage gathering tank 44 can increase. This can cause the actuator assembly 185 to command higher pumping rate by moving the plate cam 186. As the leakage flow rate increases from zero, pump assembly 36 begins pumping and can increase its pumping capacity by reciprocating at a higher frequency. Once pump assembly 36 has reached its limit of pumping capacity, the second pump assembly 36b can proportionally increase its output until it has also reached its pumping capacity limit. At this point, the system can be pumping at ⅔ of total system capacity. Further increase in leakage rate can linearly ramp up the third pump assembly 36c, in the same manner as with the first two pump assemblies.

The 3-pump system of FIG. 12 is shown as operating at 50% pumping capacity. Regulator valve assembly 182 can command pump assembly 36 through line 189 to run at full capacity as evidenced by cam follower roller 190 being beyond the cam ramp and resting on the top of the plate cam 186. Pump assembly 36b is pumping at 50% of its capacity as evidenced by the cam follower roller 190b of regulator valve assembly 183 being halfway up its corresponding cam ramp in the embodiment. The pressure in line 189b can be lower than the maximum value resulting in a corresponding reduced pump speed (reciprocating frequency). Pump assembly 36c can be idle and not functioning, as evidenced by the cam follower roller 190c of regulator valve assembly 184 not being lifted by its cam ramp.

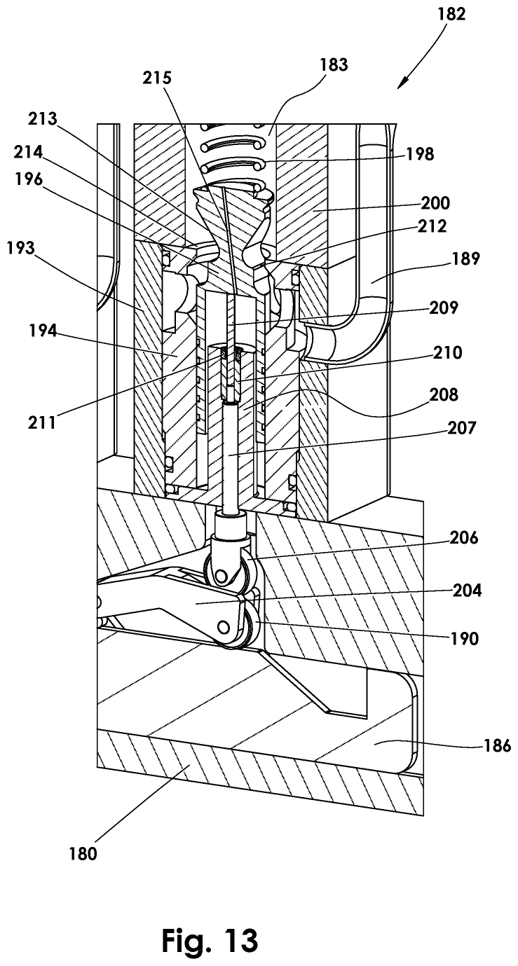

FIG. 13 shows a detailed view of regulator valve assembly 182 of an embodiment of the current technology. The speed of the corresponding pump assembly 36 can be governed by the throttling of high-pressure volume 183 by tapered throttling feature 213 of regulating valve 196. The pressure of the flow driving pump assembly 36 can be governed by the flow area through the clearance between the tapered throttling feature 213 and the valve seat edge 214. The reduced flow and pressure can be directed through regulated outlet line 189 to pump assembly 36.

The cam follower rocker arm 204 can be linked to housing 180 with a cylindrical axle. The 2-part cam follower system can eliminate side loading of the cylindrical follower 207. The side-loading due to the cam actuation can instead be taken up by the rocker arm 204 and follower roller 190. The vertical force component of cam actuation can be translated to the intermediate cam follower roller 206 and the cylindrical follower 207. The cylindrical follower 207 can slidably move within cylindrical follower guide 208 and transmit vertical motion to the small push rod 209 and on to the throttling valve 196 and spring 198. The small push rod 209 can be slidably guided by bushing 210 and sealed by seal 211. The push rod 209 can be small in diameter to minimize its axial force created by the high differential pressures on each of its ends. The lower end can be at atmospheric pressure and the upper end can have a higher pressure. Axial forces created by this pressure differential can have a profoundly negative effect on system performance as they counter the forces commanded by actuator assembly 185. For this reason, throttling valve 196 can be pressure-balanced and have a vent hole 215 to expose both of its ends to equal pressure.

As compressor packing seal leakage rate increases, the 3-pump system can initiate pumping by the second pump assembly once the first pumping assembly has reached its capacity. When the first two pump assemblies are running at capacity, the third can initiate pumping. It is important to not run a pumping assembly too slowly if the demand for its operation is marginal. Operating too slowly can result in a chattering motion due to stick-then-slip conditions. This unacceptably slow operation can also make the triggering and valving indecisive and inconsistent. To combat this scenario, the regulator valve assembly 182 can be designed so that the minimum flow (once operation is commanded) through line 189 to pump assembly 36 can be between 10-25% of the maximum flow. In order to prevent over-pumping during the transition to the next pump, the output of regulator valve assembly 182 can be trimmed. The throttling valve 196 can have a flow reducing limiter 212 that reduces the flow area between throttling valve 196 and valve seat edge 214 as the cam follower roller reaches maximum lift on top of the plate cam 186.

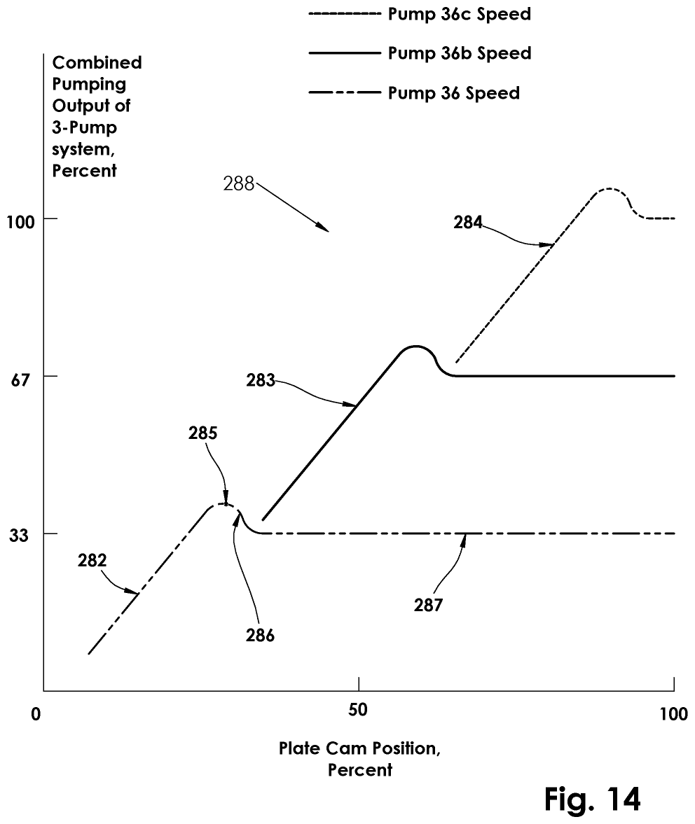

FIG. 14 shows a plot of plate cam position versus combined output of the 3-pump system according to the present technology. Line 282 represents flow through the regulator valve assembly 182 that controls the speed of pump 36. The initial sloped portion shows that the flow can be proportional to cam position. The flow can reach a maximum at point 285, then can decrease 286 down to its constant flow 287 as the cam follower roller 190 rolls onto the top of plate cam 186. This reduction while the plate cam continues its advancement can be needed because the minimum initial flow of regulator valve assembly 183 is finite and greater than zero. As leakage rate increases, the actuator assembly can command more movement of plate cam 186 because the demand for increased pumping rate has been stifled by the reduction from 285 to 287. Line 283 can correspond to regulator valve 183 and when activated, pump assembly 36b can begin operating at a speed sufficient for consistent operation. The same thing can happen at the transition to the third pumping assembly as shown by line 284.

FIG. 15 shows the blow-down diverter valve assembly 40 according to an embodiment of the technology. There are events at gas compression facilities that require that pressurized components and systems be vented to the atmosphere for maintenance, service, or compressor shut down. This technology is configurable to capture the gas of a “blow down” event and pump it back into the gas pipeline system, rather than vent it into the atmosphere. The valve diverter assembly 40 can circumvent operation of the speed control assembly 38 and supply a maximum allowable pressure to drive all pump assemblies at a maximum speed.

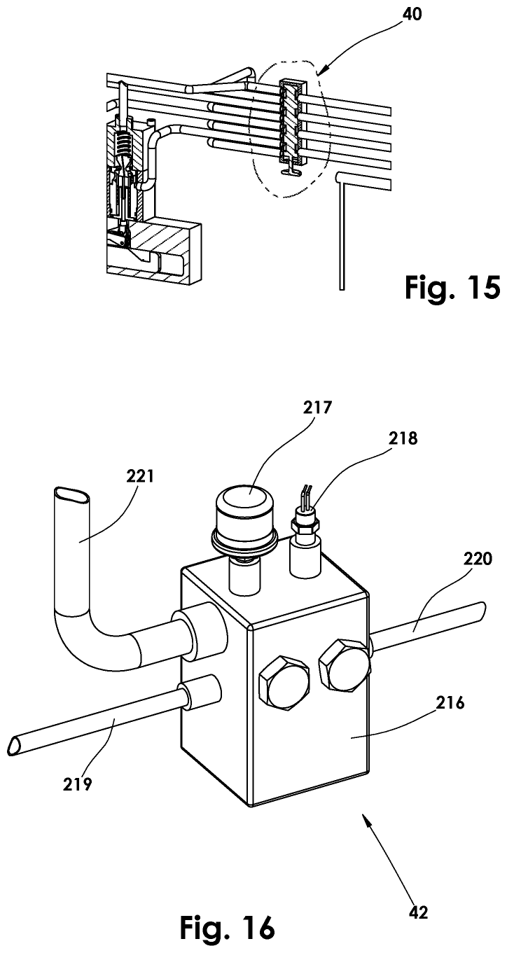

FIG. 16 shows the packing seal health monitoring system 42 according to an embodiment of the current technology. One of these assemblies can be required for each “throw” of a multi-cylinder compressor. Leakage flow can enter body 216 through inlet line 219 and exit through line 220. If the packing seals for a particular piston rod are leaking beyond an acceptable threshold, the visual fault indicator 217 can change color. Additionally, electronic sensor 218 can transmit electronic operational data. If the compressor leakage flow rate exceeds a predetermined threshold, an internal pressure relief valve can vent the leakage to the atmosphere through vent line 221.

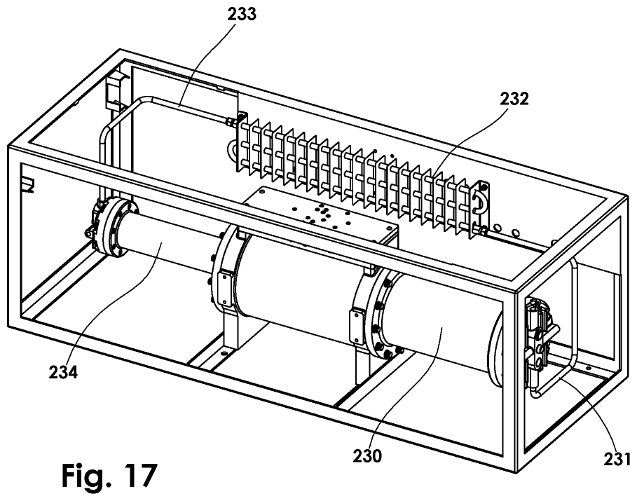

FIG. 17 shows a 2-stage version of an embodiment of the present pump assembly. There are applications for this technology where the lowest gas line pressure at a facility is higher than what this system can pump with a single stage of compression. In these instances, the depicted pump assembly can be used to further boost the pressure of the recovered natural gas. The first-stage cylinder 230 discharges through line 231, intercooler 232, line 233, and into second-stage cylinder 234.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1.-13. (canceled)

14. A method of recovering natural gas from a natural gas system comprising:
connecting at least one gas capture device to a natural gas compressor;
collecting the recovered natural gas from the at least one gas capture device in at least one collection tank;
pressurizing the recovered natural gas in the at least one collection tank with a recovered gas compression system; and
returning the recovered natural gas pressurized by the gas compression system to the natural gas system.

15. The method of claim 14 wherein the natural gas is collected when a piston rod or rotating shaft is in motion.

16. The method of claim 14 wherein the natural gas is collected when a piston rod or rotating shaft is in stationary.

17. The method of claim 14 wherein pressurization with the recovered gas compression system is based on a pressure of the recovered natural gas in the at least one collection tank.

18. The method of claim 14 further comprising:
collecting blowdowns of equipment within a specified section within the pipeline system.

19. The method of claim 14 further comprising:
monitoring a recovered natural gas flow rate.

20. The method of claim 19 further comprising:
alerting a compressor operator when the recovered natural gas flow rate exceeds a predetermined threshold flow rate.
